(19) United States
(12) Patent Application Publication
(10) Pub. No.: US 2023/0252914 A1
(43) Pub. Date: Aug. 10, 2023

(54) TIME-EXPIRING LABEL SYSTEMS AND METHODS OF MAKING

(71) Applicant: Data Management Inc., Unionville, CT (US)

(72) Inventors: Daniel A. Hincks, Burlington, CT (US); Richard F. Reed, Canton, CT (US)

(73) Assignee: Data Management Inc., Unionville, CT (US)

(21) Appl. No.: 18/164,438

(22) Filed: Feb. 3, 2023

Related U.S. Application Data
(60) Provisional application No. 63/308,619, filed on Feb. 10, 2022.

(51) Int. Cl. G09F 3/00; G09F 3/10

(52) U.S. Cl. CPC G09F 3/0291; G09F 3/10; G09F 2003/0225

(57) ABSTRACT

A time-expiring label system is provided that includes a release liner having a first label part, a second label part, and a third label part releasably secured thereto with an adhesive. The system further includes a first time-expiring component on the first label part and a second time-expiring component on the second label part. The first and second time-expiring components are configured so that, upon removal of the second label part from the release liner and placement onto the first label part, a time-expiring reaction commences. The third label part has textual and/or visual instructions for removing the second label part from the release liner and placing of the second label part onto the first label part.

### CROSS REFERENCE TO RELATED APPLICATIONS

This application claims the benefit of U.S. Application 63/308,619 filed Feb. 10, 2022, the entire contents of all of which are incorporated herein by reference.

### BACKGROUND

### 1. Field of the Invention

The present disclosure is related to a time-expiring devices and, more particularly, to time-expiring label systems and methods of making.

### 2. Description of Related Art

Time-expiring labels are known. Generally, such labels are useful because they include color changing process that starts at one color and, after a predetermined period of time has passed from activation, the color changing process results in second color being displayed. The second color can be a visual indication of the expiration of the predetermined period of time.

Examples of these prior art time-expiring labels can be found in U.S. Pat. Nos. 5,699,326, 7,263,036, 7,263,037, US Publication 2010/0012261, and others. The disclosures of these prior art examples are incorporated herein by reference.

Such labels have found wide acceptance due primarily to their ease of use, particularly in the field of security. For example, time-expiring labels have been found to be useful as identification for visitors to schools, manufacturing facilities, research facilities, and others. The expiration of the label prevents re-use of the label without the knowledge of security personnel.

Generally, the color changing process is the result of contact between two time-expiring components. Prior to activation, the time-expiring components have been kept separate to avoid inadvertent activation. When activation is desired, the two time-expiring components can be placed into contact with one another.

Some prior art label systems maintain the separation of the time-expiring components by providing two completely separate rolls of labels. These systems are often referred to as two-part systems. Here, a first part or roll of labels has a first time-expiring component, while a second part or roll of labels has a second time-expiring component. The user must take a label from each of the two rolls and place them onto one another in a manner that places the first and second time-expiring component into contact with one another to start the time-expiring reaction.

Other prior art label systems maintain the separation of the layers by providing a single roll of labels—where the roll has labels that include both the first and second time-expiring components. These systems are often referred to as one-part systems or fold-over labels. The first and second time-expiring components are positioned on each label in a manner that allows the user to fold the label to start the time-expiring reaction between the components.

It has been found by the present invention that each of these prior art systems present challenges in high material costs, manufacture, storage, inventory, and use. Thus, it has been found that there is a continuing need for improved time-expiring label systems and methods of making.

### SUMMARY

Advantageously, the time-expiring label system of the present disclosure provides a simple one-piece label system that vastly reduces the quantity of the most expensive material, eliminates complex manufacturing processes required for fold-over labels—while also providing for an instruction indicator on each label. In a typical implementation, the most expensive component is reduced by 90%.

A time-expiring label system is provided that includes a release liner having a first label part, a second label part, and a third label part releasably secured thereto with an adhesive. The system further includes a first time-expiring component on the first label part and a second time-expiring component on the second label part. The first and second time-expiring components are configured so that, upon removal of the second label part from the release liner and placement onto the first label part, a time-expiring reaction commences. The third label part has textual and/or visual instructions for removing the second label part from the release liner and placing of the second label part onto the first label part.

In some embodiments either alone or together with any one or more of the aforementioned and/or after-mentioned embodiments, the system further includes a plurality of score lines dividing the release liner into a plurality of label regions.

In some embodiments either alone or together with any one or more of the aforementioned and/or after-mentioned embodiments, each of the plurality of label regions have one of the first, second, and third parts.

In some embodiments either alone or together with any one or more of the aforementioned and/or after-mentioned embodiments, the release liner further includes one or more printer indexing marks and/or a kiss cut region at least in an area of the second label part.

In some embodiments either alone or together with any one or more of the aforementioned and/or after-mentioned embodiments, the one or more printer indexing marks are between the third label part of one of the plurality of label regions and the first label part of an adjacent of the plurality of label regions.

In some embodiments either alone or together with any one or more of the aforementioned and/or after-mentioned embodiments, the first time-expiring is a migrating ink.

In some embodiments either alone or together with any one or more of the aforementioned and/or after-mentioned embodiments, the migrating ink is configured to migrate upon contact with the second time-expiring component.

In some embodiments either alone or together with any one or more of the aforementioned and/or after-mentioned embodiments, the migrating ink is configured to migrate so that a message is visible after a predetermined period of time through the second label part.

In some embodiments either alone or together with any one or more of the aforementioned and/or after-mentioned embodiments, the system further includes a gap between the first and second label parts, the gap being sufficient to mitigate transfer of the second time-expiring component onto the first time-expiring component.

A method of using a time-expiring label system is also provided. The method includes the steps of providing a release liner having a first label part, a second label part, and a third label part releasably secured thereto with an adhesive; removing the second label part from the release liner, the adhesive on the second label part has a second time-expiring component; and placing the second label part on a region of the first label part, the region having a first time-expiring component. The contact of the first and second time-expiring component activates a time-expiring reaction. The third label part has textual and/or visual instructions describing the removing and placing steps.

The above-described and other features and advantages of the present disclosure will be appreciated and understood by those skilled in the art from the following detailed description, drawings, and appended claims.

### BRIEF DESCRIPTION OF THE SEVERAL VIEWS OF THE DRAWINGS

FIG. 1 shows an exemplary embodiment of a time-expiring label system before use;

FIG. 2 shows the time-expiring label system of FIG. 1 after printing;

FIG. 3 shows the time-expiring label system of FIG. 1 during activation;

FIG. 4 shows the time-expiring label system of FIG. 1 in a use condition;

FIG. 5 shows the time-expiring label system of FIG. 1 after expiration;

FIG. 6 shows a first portion of the time-expiring label system of FIG. 1, prior to assembly; and

FIG. 7 shows a second portion of the time-expiring label system of FIG. 1, prior to assembly.

### DETAILED DESCRIPTION OF THE INVENTION

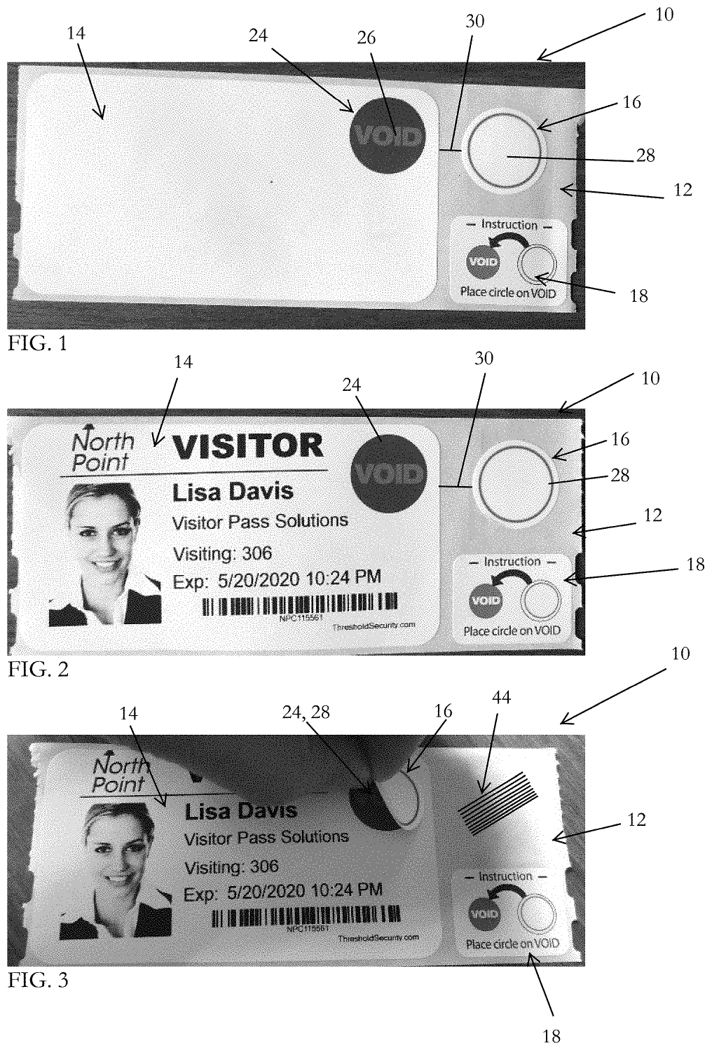

Referring to the drawings and in particular with simultaneous reference to FIGS. 1-5, a first exemplary embodiment of a time-expiring label system according to the present disclosure is shown and is generally referred to by reference numeral 10.

For purposes of clarity, system 10 is illustrated herein by way of example only in use as a visitor security label. Of course, it is contemplated by the present disclosure for system 10 to find use in any application where a self-expiring indicator is desired such as, but not limited to, a security label, a product label, an entrance label, a usage pass, a card (e.g., an access card, a credit card, debit card), a ticket, and others.

System 10 is shown in FIG. 1 before use. System 10 includes a release liner or backing 12, a first label part 14, a second label part 16, and a third label part 18. Parts 14, 16, 19 are removably secured to liner 12 by an adhesive (not shown).

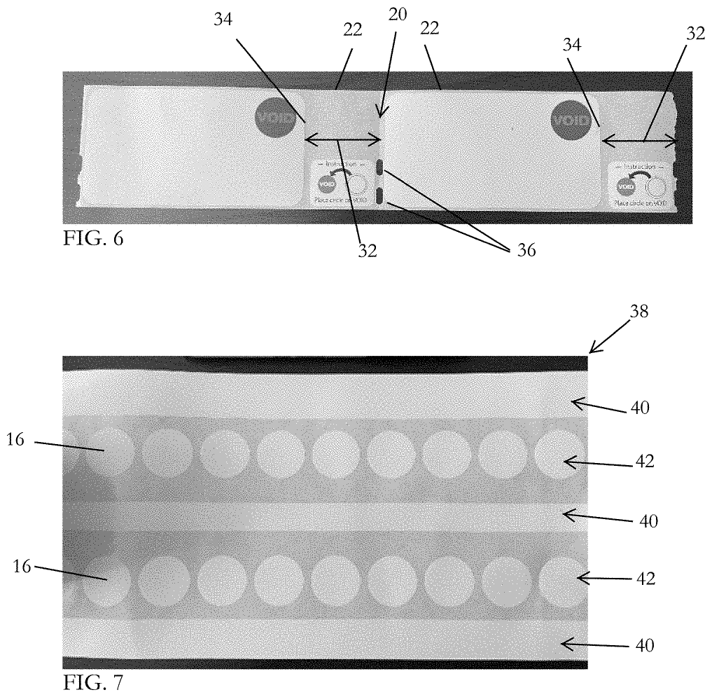

Liner 12 includes a plurality of score lines 20 that divide the liner into separate label regions 22. System 10 is shown in FIG. 1 after separating liner 12 at lines 20 such that two partial score lines 20 are shown at each edge. In addition, system 10 is shown in FIG. 6 prior to separation of liner 12 at lines 20.

Score lines 20 can be any line of weakness defined within liner 14. For example, it is contemplated by the present disclosure for score lines 20 to be formed by a one or more perforations and/or thinned sections on one or both surfaces of the liner.

Each label region 22 includes one each of parts 14, 16, and 18.

First label part 14 includes a first time-expiring component 24 such as, but not limited to, a migrating ink or dye on or within the first label part. In this manner, first part 14 can be a simple, inexpensive paper label with first component 24.

In some embodiments, first part 14 can be blank or free from other indicia as shown in FIG. 1, which allows the first part to be printed on at the time of use using commercially available label printers as shown in FIG. 2. When system 10 is configured for use with a printer, first part 14 can include one or more printer or indexing marks 36 as shown in FIG. 3.

In other embodiments, first part 14 can have some pre-printed indica (not shown) that includes, for example, a company name or logo, while the remaining portion of the first part can be blank or free, which allows the remaining portion to be printed on at the time of use using commercially available label printers.

In some embodiments, first component 24 can include a message 26 defined therein. In the illustrated embodiment, message 26 is shown as “void”. Of course, it is contemplated by the present disclosure for message 26 to provide any textual or visual indicia.

Second label part 16 includes a second time-expiring component 28. Second time-expiring component 28 can be in the adhesive removably securing the second label part to the liner. In some embodiments, second time-expiring component 28 is an adhesive vinyl specifically configured to allow transfer onto liner 12 during manufacture of system 10 and to allow transfer from liner 12 onto the desired surface during use of the system by the user.

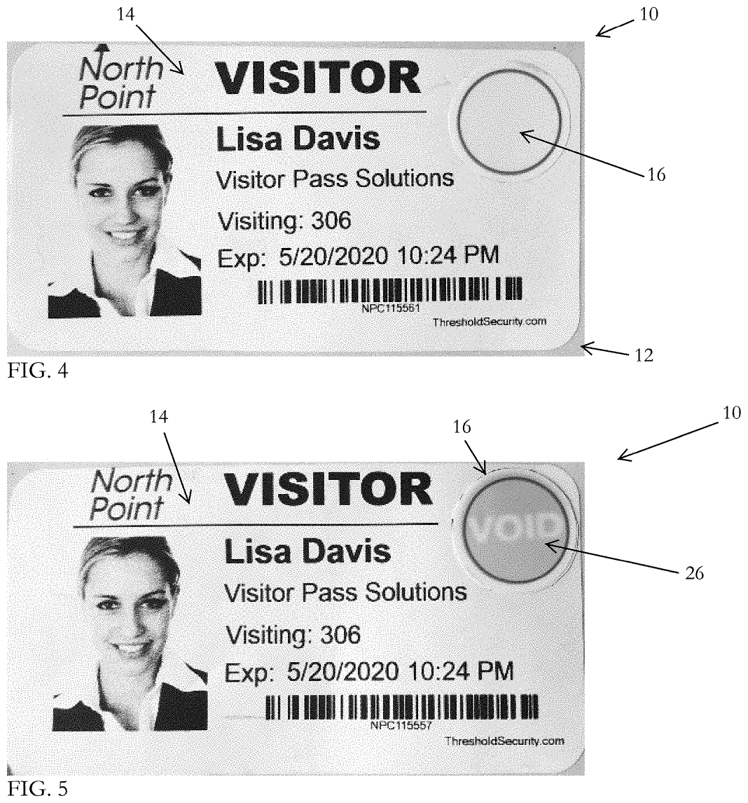

During use as shown in FIGS. 3-4, second part 16 is removed from liner 12 and placed onto first part 14 so that second time-expiring component 28 is adhered to first time-expiring component 24 of first label part 14 to activate the time expiring components in a known manner. Once activated, first component 24 migrates through second part 16, after a predetermined time, until message 26 is visible through the second part as shown in FIG. 5.

For example, when activated, second component 28 can dissolve one or more components of first component 24 causing the first component to bleed or diffuse through second label part 16 to the top of the second label part at a controlled rate with the resulting image being a color change on the top of the second label part, which can be seen by those viewing the label. Such a color changed label is indicative that the label is “expired” and cannot be used again. When first component 24 includes message 26, the message can be seen by those viewing the label as shown in FIG. 5.

System 10 is configured so that second part 16 is spaced from first part 14 by a gap 30 shown in FIGS. 1 and 2. Gap 30 is sufficient to ensure that pressure on second part 16 from manufacturing, storage on a roll, pulling through printer, and others does not result in second time-expiring component 28 migrating onto first part 14 in the region of first time-expiring component 24. Stated differently, it has been determined by the present disclosure that second time-expiring component 28, when in adhesive form, can flow out from under second part 16 due to pressure applied to system 10. When second time-expiring component 28 flows out from under second part 16 it can result in inadvertent activation of first time-expiring component 24. Gap 30 has been found to mitigate such inadvertent activation.

Further, system 10 can be configured so that heat applied to second part 16 during use with a thermal or toner printer does not act as a catalyst to commence the time-expiring reaction.

It should be recognized that first component 24 and second label part 16 are shown by way of example as both being circular. Of course, it is contemplated by the present disclosure for system 10 to have first component 24 and second label part 16 that have shapes different from one another. It is also contemplated by the present disclosure for system 10 to have second label part 16 of a specific shape—such as the shape of a company logo.

Third label part 18 includes a textual and/or graphical instruction indica, which provides assembly instructions to the user for assembling second label part 16 onto first label part 14. Similar to first part 14 discussed above, third part can be a simple, inexpensive paper label.

Thus, system 10 has all three parts 14, 16, and 18 on liner 12 that can be rolled up into a single roll of multiple labels (i.e., regions 22) separated by score lines 20 in a known manner. The roll (not shown) can be fed through a printer (also not show) so that first part 14 can be printed on at the time of use.

Advantageously, first and second parts 14, 16 are delivered together on a single liner 12 such that system 10 eliminates the need for separate rolls of the two time-expiring components 24, 28. Further, third part 18 ensures that the user knows how to activate system 10 by giving textual and/or graphical instructions on how to place second part 16 onto first part 14 without training or being familiar with the system.

In some embodiments, the user can remove first label part 14, having second label part 16 adhered thereto, from liner 12 and adhere the first label part to their clothing in a known manner. In other embodiments, the user can remove first label part 14 from liner 12 and adhere the first label part to their clothing in a known manner, then remove second label part 16 from liner 12 and adhered the second label part onto the first label part 14.

After first and second label parts 14, 16 are removed from liner 12, the liner and third label part 18 can be discarded.

Referring now to FIGS. 6 and 7, the method of making system 10 is disclosed in more detail. The method is configured to combine second label part 16 onto the same liner 12 as first and third label parts 14, 18 with gap 30.

FIG. 6 shows system 10 prior to application of second label part 16 onto liner 12. As discussed above, each region 22 of liner 12 has one each of first, second, and third parts 14, 16, 18. In order to accommodate all three parts and gap 30, score line 20 is positioned to provide a sufficient distance 32 between an edge 34 of first part 14 and the score line.

During application of second part 16 onto liner 12, the liner having the first and third 14, 18 parts already thereon is pulled through a transfer machine.

However, distance 32 results in the area of liner 12, prior to receipt of second part 16, having a different property (e.g., thickness, flexibility, tear strength) as compared the remaining portions of the liner, which can make transfer of second part 16 onto the liner difficult.

Further, distance 32 results in liner 12, after receipt of second part 16, having a different property (e.g., thickness, flexibility, tear strength) in the region with second part 16 as compared to the portions of the liner that have first and third parts 14, 18, which can also make transfer of second part 16 onto the liner difficult.

As noted above, liner 12 can include one or more indexing marks 36, which are used during printing on first and/or third parts 14, 18. In one embodiment, marks 36 are preferably positioned between third part 18 of one region 22 and first part 14 of an adjacent region.

In some embodiments, liner 12 includes a kiss cut region 44 (FIG. 3) at least in the area where second part 16 is to be placed. It has been found by the present application that kiss cut region 44 ensures that the adhesive label being removed from liner 12 from which first and third parts 12, 18 are formed can be easily separated and removed from the liner without damage to the liner.

FIG. 7 shows a supply 38 of second label portions 16 prior to application onto liner 12. Here, supply 38 has a one or more rails 40 of label material at the edges and/or center thereof. In the illustrated embodiment, supply 38 has two spaced apart rows 42 of second label portions 16—with a rail 40 at the edges and between the two rows.

Of course, it is contemplated by the present disclosure for supply 38 to have more or less than two rows 42 with between one and ten rows being preferred, and between two and six rows being more preferred, with four rows being most preferred, and any subranges therebetween.

Further, it is contemplated by the present disclosure for supply 38 to have more or less rails 40 and/or for rails to be made of the same or different material as second parts 16.

Without wishing to be bound by any particular theory, it has been found that rails 40 reduce the flow of the adhesive having second time-expiring component 28 during removal of second label parts 16 from supply 38 and during application of the second label part onto liner 12. Stated differently, it has been determined by the present disclosure that second time-expiring component 28, when in adhesive form, can flow out from under second part 16 due to pressure applied to supply 38 during manufacture, storage, and transfer for second label parts 16 onto system 10. When second time-expiring component 28 flows out from under second part 16, it can prevent proper transfer of second part 16 onto system 10 by causing the second part 16 to get stuck on the transfer machines and/or the roll of supply 38. Moreover, adhesive flow can result in inadvertent activation of first time-expiring component 24 by transfer of the adhesive onto the first component.

As noted above, second time-expiring component 28 is an adhesive vinyl specifically configured to allow transfer onto liner 12 during manufacture of system 10 and to allow transfer from liner 12 onto the desired surface during use of the system by the user. The specific configuration can include the use of rails 40 to distribute pressure on supply 38. The specific configuration can include the use of gap 30 to distance second part 16 from first part 14.

Furthermore and without wishing to be bound by any particular theory, the specific configuration of second time-expiring component 28 can include a viscosity increase as compared to stock time expiring adhesives and/or a change in thickness of the adhesive to enable the transfer of second label part 16 from a supply 38 onto liner 12, while minimizing flow of the adhesive from under second label part 16, which is an issue that is unique to the configuration of system 10.

As noted above, second time-expiring component 28 is the most expensive component of system 10. Thus, the specific configuration of and manufacturing process to form system 10 provides cost advantages not possible from the prior art fold-over systems, while providing an enhanced user experience as compared to the prior art two-part systems.

In prior art fold-over systems, the expensive time expiring component is used on the entire label. In the example of a typical label size of 5 inches by 2 inches, 10 square inches of the expensive time expiring component is needed since these systems require coverage across all 10 square inches of the label, as well as across any portion of the stock removed around the die cut label.

By contrast, system 10 is configured so that first and third parts 14, 18 use common, low-cost adhesives and materials, while only second part 16 includes the higher cost second time-expiring component 28. As illustrated in FIG. 1, first part 12 is shown in the same dimensions as the prior art example discussed above of 5 inches by 2 inches, but includes second part 16 with a size of approximately 1 inch in diameter that is die cut from a 1 inch by 1 inch portion of stock 38. Thus, system 10 requires only 1 square inch of the higher cost second time-expiring component 28 as compared to the 10 square inches of the prior art fold-over systems.

Even when taking into account the portions of supply 38 that are cut away to provide second part 16 and the rails 40 that left un-used after forming system 10, the cost savings of second time-expiring component 28 can still reach upwards of 90% over the prior art fold-over systems.

It should also be noted that the terms “first”, “second”, “third”, “upper”, “lower”, “top”, “bottom”, and the like may be used herein to modify various elements. These modifiers do not imply a spatial, sequential, or hierarchical order to the modified elements unless specifically stated.

While the present disclosure has been described with reference to one or more exemplary embodiments, it will be understood by those skilled in the art that various changes may be made and equivalents may be substituted for elements thereof without departing from the scope of the present disclosure. In addition, many modifications may be made to adapt a particular situation or material to the teachings of the disclosure without departing from the scope thereof. Therefore, it is intended that the present disclosure not be limited to the particular embodiment(s) disclosed as the best mode contemplated, but that the disclosure will include all embodiments falling within the scope of the appended claims.

### LIST OF REFERENCE NUMERALS

time-expiring label system 10
release liner or backing 12
first label part 14
second label part 16
third label part 18
score lines 20
separate label regions 22
first time-expiring component 24
message 26
second time-expiring component 28
gap 30
distance 32
edge 34
indexing marks 36
supply 38
rails 40
rows 42
kiss cut region 44

What is claimed is:

1. A time-expiring label system, comprising:
a release liner having a first label part, a second label part, and a third label part releasably secured thereto with an adhesive;
a first time-expiring component on the first label part;
a second time-expiring component on the second label part, the first and second time-expiring components being configured so that, upon removal of the second label part from the release liner and placement onto the first label part, a time-expiring reaction commences,
wherein the third label part comprises textual and/or visual instructions for removing the second label part from the release liner and placing of the second label part onto the first label part.

2. The system of claim 1, further comprising a plurality of score lines dividing the release liner into a plurality of label regions.

3. The system of claim 2, wherein each of the plurality of label regions comprise one of the first, second, and third parts.

4. The system of claim 2, wherein the release liner further comprises a kiss cut region at least in an area of the second label part.

5. The system of claim 2, wherein the release liner further comprises one or more printer indexing marks at least in an area of the second label part.

6. The system of claim 5, wherein the one or more printer indexing marks are between the third label part of one of the plurality of label regions and the first label part of an adjacent of the plurality of label regions.

7. The system of claim 5, wherein the release liner further comprises a kiss cut region at least in the area of the second label part.

8. The system of claim 1, wherein the first time-expiring component is a migrating ink.

9. The label of claim 8, wherein the migrating ink is configured to migrate upon contact with the second time-expiring component.

10. The label of claim 9, wherein the migrating ink is configured to migrate so that a message is visible after a predetermined period of time through the second label part.

11. The system of claim 1, further comprising a gap between the first and second label parts, the gap being sufficient to mitigate transfer of the second time-expiring component onto the first time-expiring component.

12. A method of using a time-expiring label system, comprising:
providing a release liner having a first label part, a second label part, and a third label part releasably secured thereto with an adhesive;
removing the second label part from the release liner, the adhesive on the second label part comprising a second time-expiring component; and
placing the second label part on a region of the first label part, the region having a first time-expiring component, wherein the contact of the first and second time-expiring component activates a time-expiring reaction,
wherein the third label part comprises textual and/or visual instructions describing the removing and placing steps.
